(19) United States
(12) Patent Application Publication
(10) Pub. No.: US 2025/0289001 A1
(43) Pub. Date: Sep. 18, 2025

(54) METAL MATRIX COMPOSITE GRINDING BALL

(71) Applicant: Magotteaux International S.A., Vaux-sous-Chèvremont (BE)

(72) Inventors: Stéphane DESILES, Aywaille (BE); Marc BABINEAU, Beaufays (BE); Marc MERTENS, Spa (BE)

(21) Appl. No.: 18/862,906

(22) PCT Filed: Jun. 13, 2023
(86) PCT No.: PCT/EP2023/065807

§ 371 Date: Nov. 4, 2024

(30) Foreign Application Priority Data
Jul. 1, 2022 (EP) 22182591.2

(51) Int. Cl. B02C 17/20; B28B 1/30; C22C 1/051; C22C 29/04; C22C 29/06; C22C 29/08; C22C 29/10; C22C 38/04; C22C 38/08; C22C 38/12; C22C 38/22

(52) U.S. Cl. CPC B02C 17/20; C22C 1/051; C22C 29/04; C22C 29/067; C22C 29/08; C22C 29/10; C22C 38/04; C22C 38/08; C22C 38/12; C22C 38/22; B28B 1/30

(57) ABSTRACT

A composite grinding ball has a core-shell structure. The shell has a ceramic reinforcement including a three-dimensionally interconnected network of periodically alternating ceramic metal composite granules with interstices having an average size within the millimetric range. The ceramic metal composite granules have at least 40 vol % of ceramic particles cemented in a binder metal matrix, the ceramic particles having average sizes within the micrometric range. The three-dimensionally interconnected network is embedded in a ferrous alloy cast metal matrix that fills the interstices between the interconnected ceramic metal composite granules. The embedded ceramic metal composite granules have a volume fraction of porosity of less than 5 vol %. The shell has a volume content of ceramic metal composite granules of at least 35 vol %, and the ceramic reinforcement covers at least 85% of the total surface of the grinding ball.

### FIELD

The present disclosure relates to a composite grinding ball, in particular a core-shell composite grinding ball obtained by conventional cast technology and having an improved resistance to the combined wear and impact stresses.

### INTRODUCTION

The present disclosure relates to a hard-wearing composite grinding ball employed in tumbling mills in the grinding industry, typically for clinker grinding in cement factories or ore grinding in mines. Grinding balls are often subjected to high impact stresses and to high wear by abrasion or corrosion. It is therefore desirable that grinding balls should exhibit a high abrasion and corrosion wear resistance and some ductility to be able to withstand the mechanical stresses such as ball on ball or ball on liner impacts.

Given that these two properties are difficult to match with the same material composition, metal ceramic composite grinding balls have been proposed.

Document CN 106914620A (2017) discloses a preparation method of a ceramic/metal composite grinding ball, using selective laser cladding combined with 3-dimensional digital modelling technique, with a precast body honeycomb structure, placed in the cavity before casting.

Documents CN103357854 (2013) and CN113564511A (2021) disclose ceramic reinforced grinding balls, the reinforcing layer comprising inlaying nanometer-grade ceramic particles on the surface and the sub-surface of the grinding ball. The casting mold being coated with nanometric ceramic particles on the inner wall.

Document CN104707972 A (2015) discloses a composite grinding ball having a core-shell structure having a ceramic reinforcement embedded in a ferrous alloy cast metal matrix. This document neither discloses specific ceramic metal composite granules with a specific vol % of ceramics cemented in a binder metal matrix nor a three-dimensionally interconnected network of periodically alternating ceramic metal composite granules with interstices, both in the millimetric range.

Document CN109128098A (2019) discloses a method for the manufacturing of ceramic metal composites using a Al₂O₃—ZrO₂ powder transformed into a plurality of ceramic core pieces in a mold wherein a grinding ball is later cast with manganese steel. This document neither discloses any ceramic particles cemented in a binder metal matrix nor an interconnected network of periodically alternating ceramic metal composite granules of this cemented particles.

Document EP3885061 A1 (Magotteaux 2021) discloses a hierarchical composite wear component comprising a reinforcement of a three-dimensionally interconnected network of periodically alternating millimetric ceramic-metal composite granules with millimetric interstices, the millimetric ceramic-metal composite granules being of low porosity.

The grinding ball market is price sensitive and therefore an optimum of wear performance and price must be respected and the manufacturing adapted accordingly. The realization of the ceramic precast shell body/hollow ball of aggregated ceramic metal granules in an economic way, its solidity during the cast operation and its ability to be infiltrated by the cast metal without damage is of major importance.

### SUMMARY

The present disclosure aims to provide a ceramic reinforced core-shell grinding ball produced by conventional casting comprising a metal matrix of cast iron or steel and integrating a reinforced shell structure of ceramic metal granules of low porosity with a high concentration of micrometric ceramic particles cemented in a metallic binder matrix. The grinding ball of the present disclosure comprises a reinforcement shell of a precast ceramic body consisting of assembled shells, in particular two half shells, with at least one inflow hole for the cast metal. The shells comprise a three-dimensional interconnected network of aggregated ceramic metal composite granules with interstices, both in a millimetric size range, wherein ceramic micrometric particles are cemented in a binder metal matrix, the millimetric interstices being infiltrated and filled by the cast metal matrix.

The present disclosure discloses a composite grinding ball having a core-shell structure, the shell of the core-shell structure comprising a ceramic reinforcement, the ceramic reinforcement comprising:
a three-dimensionally interconnected network of periodically alternating ceramic metal composite granules with interstices, the ceramic metal composite granules and interstices having an average size within the millimetric range;
the ceramic metal composite granules comprising at least 40 vol %, preferably at least 60 vol %, most preferably at least 70 vol % of ceramic particles cemented in a binder metal matrix, the ceramic particles having average sizes within the micrometric range;
the three-dimensionally interconnected network of ceramic metal composite granules with interstices being embedded in a ferrous alloy cast metal matrix, wherein the ferrous alloy cast metal matrix fills the interstices between the interconnected ceramic metal composite granules of the three-dimensionally interconnected network; the ceramic metal composite granules embedded in the ferrous alloy cast metal matrix having a volume fraction of porosity of less than 5 vol %, preferably less than 3 vol %, most preferably less than 1 vol %, the porosity measurement being based on ISO 13383-2:2012 Annex A;
the shell comprising a volume content of ceramic metal composite granules of at least 35 vol %, preferably at least 45 vol %;
the ceramic reinforcement of the shell covering at least 85%, preferably 90%, most preferably 95% of the total surface of the grinding ball.

The present disclosure further discloses at least one or an appropriate combination of the following structural features:
the ceramic particles are selected from the group consisting of carbides, nitrides, carbonitrides and borides or mixes thereof;
the ceramic particles are selected from the group consisting of titanium carbide, titanium carbonitride, tungsten carbide, niobium carbide, vanadium carbide, zirconium carbide, tantalum carbide, hafnium carbide and molybdenum carbide;
the thickness of the ceramic reinforced shell ranges between 2 and 15 mm, preferably between 2 and 10 mm, most preferably between 3 and 8 mm;
the embedded ceramic metal composite granules have a particle size distribution between 0.3 and 10 mm and an average granule size D₅₀ between 1 and 4 mm, preferably between 1 and 3 mm and wherein the average particle size D₅₀ can be measured by performing a photo-micrographic view, such that there are at least 250 ceramic metal composite granules across a field of view of one or more polished cross sections of one or more samples, using a computer program and optical microscope wherein an appropriate threshold allows a segmentation of the granules in grayscale image and background;
the cemented ceramic particles in the binder metal matrix have a particle size between 0.1 and 50 μm, preferably 0.1 and 30 μm and an average particle size D₅₀ between 0.5 and 20 μm, preferably between 1 and 10 μm;
the binder metal matrix is selected from the group consisting of ferromanganese-based alloy, ferrochromium-based alloy and nickel-based alloy;
the ferro alloy cast metal matrix comprises high chromium white iron, comprising at least 11 wt % of chromium, or steel.

The present disclosure further discloses a method for the manufacturing of the composite grinding ball of the present disclosure comprising the steps of:
providing or manufacturing ceramic metal composite granules comprising at least 40 vol % of micrometric ceramic particles cemented in a binder metal matrix, the ceramic metal composite granules having a porosity of less than 5 vol %, preferably less than 3 vol %, in particular less than 1 vol %;
manufacturing ceramic precast body shells, preferably in the form of half shells, of a three-dimensionally interconnected network of periodically alternating millimetric ceramic metal composite granules obtained in step a) with millimetric interstices;
assembling the shells obtained in step b) into a hollow spheres comprising one or two inflow openings and positioning the hollow spheres in the cavities of the mold of the grinding balls to be cast;
pouring the grinding balls and simultaneously infiltrating the millimetric interstices of the three-dimensionally interconnected network of the shells, positioned according to step c), with the ferro alloy cast metal matrix;
demolding the composite grinding balls.

The present disclosure further discloses at least one or a relevant combination of the following method features:
the manufacturing process of the ceramic metal composite granules of step a), comprises:
   grinding powder compositions comprising the ceramic particles and the binder metal matrix in presence of a solvent;
   mixing 1 to 10%, preferably 1 to 6% of wax to the powder composition;
   removing the solvent by drying to obtain an agglomerated powder;
   compacting the agglomerated powder into strips, sheets or rods;
   crushing the strips, sheets or rods into granules in the millimetric size range;
   sintering the ceramic metal granules at a temperature between 1200-1600° C. in a vacuum or inert atmosphere furnace until a porosity of less than 5 vol %, preferably less than 3 vol %, yet less than 1 Vol % of is reached;
the step of grinding powder compositions comprising ceramic particles and the binder metal matrix in presence of a solvent is performed until an average particle size D₅₀ between 1 and 20 μm, preferably between 1 and 10 μm is obtained, the particle size of the powder being measured by laser diffraction with the MIE theory according to guidelines given in ISO 13320:2020 wherein the refractive index and absorption is adapted to the ceramic particles and the obscuration in the range of 10 to 15%, and the weighted residual being less than 1%.
the sintered granules crushed from strips, sheets or rods have a particle size between 0.3 and 10 mm, preferably 0.4 and 6 mm, the average particle size D₅₀ being selected between 1 and 6 mm, preferably between 1 and 3 mm the granule size being measured by dynamic image analysis according to ISO 13322-2:2006, or by sifting according to ISO 4497:2020.
step b) comprises the steps of:
   mixing the ceramic metal composite granules obtained according to the preceding step with about 0.5 to 7 wt %, preferably 1 to 4 wt % of adhesive, preferably an organic adhesive;
   pouring and compacting the mix in a shell mold;
   drying the mix at appropriate temperature and time to remove the solvent of the glue or enable curing by gazing or catalyst;
   demolding the dried mix and obtaining shells of the three-dimensionally interconnected network of periodically alternating millimetric ceramic metal composite granules with millimetric interstices, to be assembled into a hollow precast body positioned in the composite grinding ball mold.

### BRIEF DESCRIPTION OF THE DRAWINGS

FIG. 1 shows a conventional grinding ball of the prior art produced by conventional casting with a high chromium ferro alloy.

FIG. 2 shows a mold used to shape two half shells of aggregated ceramic metal granules destined to reinforce the outer shell structures of the grinding ball.

FIG. 3 shows two half shells of aggregated ceramic metal granules pressed in the mold of FIG. 2 to be assembled in a ball-shape precast body with inflow opening and placed into the cavity of the cast mold.

FIG. 4 shows a detail of the aggregated ceramic metal granules of a millimetric size range constituting the half shells of aggregated ceramic metal granules.

FIG. 5 shows an assembling of two half shells shaped in the mold of FIG. 2. The obtained reinforcement hollow sphere (hollow ball-shape precast body) of aggregated ceramic metal granules of a millimetric size range exhibit a hole/inflow hole allowing the cast metal flow into the ball mold to infiltrate the three-dimensional ceramic metal shell structure, to fill the interstices between the ceramic metal grains.

FIG. 6 represents a similar structure than in FIG. 5. The ceramic metal granule reinforcement hollow sphere exhibit two inflow holes for allowing the cast metal to cross the hollow sphere when an additional grinding ball is cast in the same branch of the mold. (see FIG. 9 where the grinding balls are cast in clusters)

FIG. 7 represents the reinforcement hollow spheres with two inflow holes of FIG. 6 positioned into the cavity of the sand mold before casting in a cluster structure (see FIG. 9).

FIG. 8 represents schematically the manufacturing and assembling of the sand mold and the positioning of the reinforcement hollow spheres in the cavities of the created sand mold.

FIG. 9 represents schematically the configuration of a mold for grinding balls cast in clusters.

FIG. 10 is a section view of a cast grinding ball according to the present disclosure showing the reinforcement in the outer shell of the grinding ball.

FIG. 11 is a detail view of a polished section of a portion of an 80 mm grinding ball showing the details of the ceramic metal grains surrounded by the cast metal.

FIG. 12 represents microscopic TiC particles cemented in a binder metal matrix. The picture is a high magnification of a part of one single ceramic metal composite granule represented in FIG. 4.

FIG. 13 is a schematic representation of the concept of the present disclosure based on a scale difference between the cemented ceramic micrometric particles (grains) in a metal binder matrix forming millimetric granules of ceramic metal composite integrated in the form of a three-dimensional network in the reinforced part of the wear component.

FIG. 14 is a representation of a cross section of a sample comprising granules in the reinforcement shell, this cross section being used in the method to obtain the ceramic metal granule average particle size D₅₀.

FIG. 15 is a schematic representation of the method to measure the Feret diameter being used in the method to obtain the ceramic metal granule average particle size D₅₀ (as explained below).

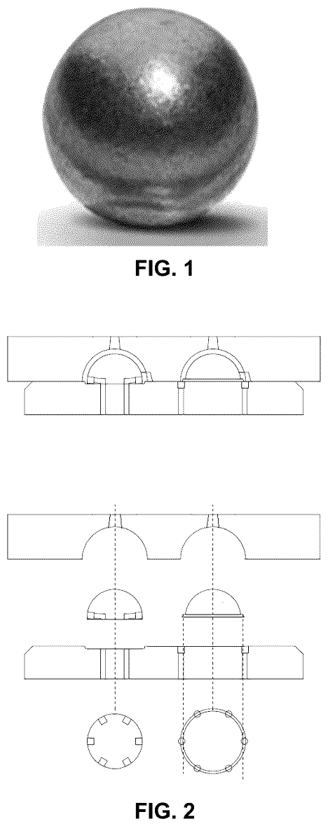

### DETAILED DESCRIPTION

The present disclosure relates to a metal matrix composite grinding ball and in particular to a ceramic reinforced grinding ball produced by conventional casting. It consists of a metal core surrounded by a reinforced shell structure comprising a network of dense irregular ceramic metal composite granules with a porosity of less than 5 vol %, preferably less than 3 vol % or 2 vol %, more preferably less than 1 vol % and a particle size distribution of about 0.3 to 10 mm, preferably 0.8 to 6 mm, and average particle sizes from 1 to 4 mm, preferably from 1 to 3 mm alternating with millimetric average interstices of 0.5 to 4 mm, preferably 1 to 3 mm.

The ceramic metal composites granules are composed of ceramic particles, in particular borides, nitrides or carbide particles such as TiC, TiCN, NbC, TaC, WC, preferably titanium carbide, titanium nitride or titanium carbonitride cemented in a metallic binder matrix.

For wear applications, the ceramic particles provide high wear resistance while the metal improves, amongst other properties, the toughness. Dependent on their specific use (impact, abrasion or corrosion resistance requested), the ceramic metal composite granules of the reinforced grinding balls of the present disclosure comprise various proportions of micrometric ceramic particles (40 to 95 vol % of the granules, preferably 60 to 90 vol %, more preferably 70 to 90 vol %, with a size from about 0.1 to 50 μm, preferably 0.5 to 20 μm, more preferably 1 to 10 μm) cemented in a metallic binder phase that can for example be Fe-based, Ni-based or Mo-based.

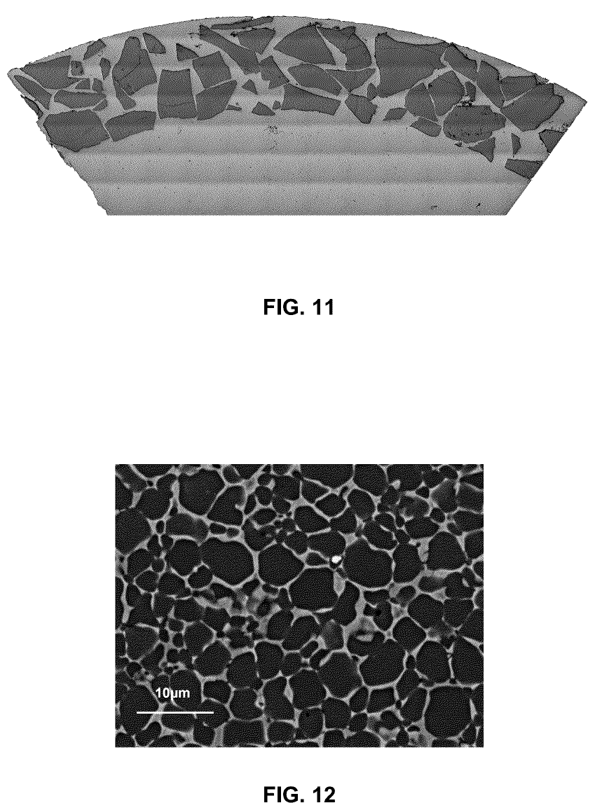

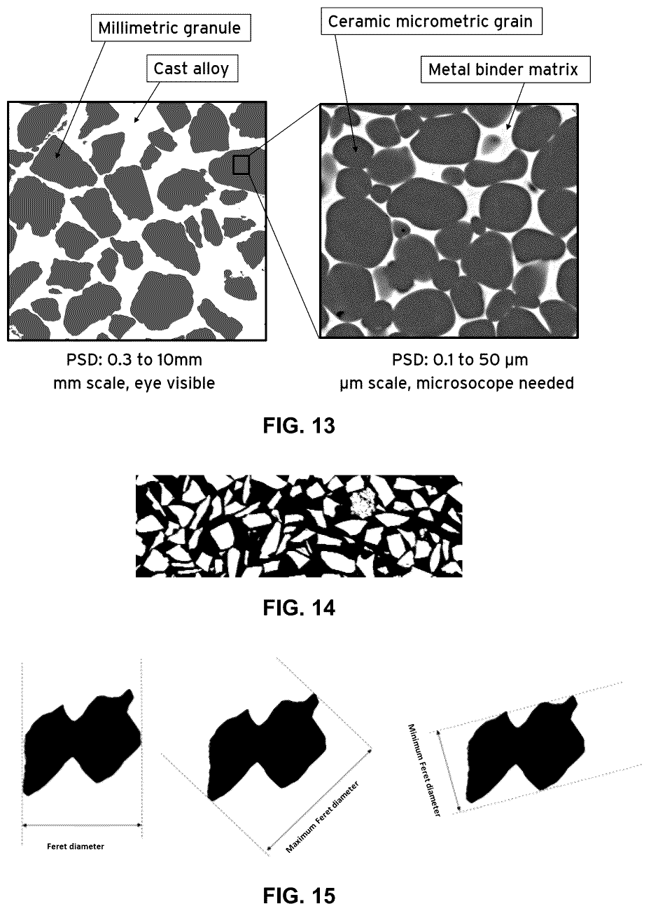

The hollow pre-cast ceramic metal shell structure/hollow balls are positioned in the mold cavity before a ferrous alloy, preferably chromium cast iron or steel, is poured into the grinding ball mold (cluster mold) and infiltrates the interstices of the outer ceramic metal shell structure surrounding the core of the grinding ball. The millimetric ceramic metal grains are then completely embedded in the cast metal matrix see FIGS. 10 and 11. The thickness of the precast shell body is variable and can be chosen between about 2 and 15 mm, preferably between 2 and 10 mm and most preferably between 3 and 8 mm.

The following table illustrates the theoretically possible reinforcement ratios considering the grinding ball diameter and the reinforced shell thickness. Grinding balls between 10 and 125 mm are commercialized for various applications, but the most common diameters are represented below. For a grinding ball of a nominal diameter of 80 mm with a reinforcement shell of only 5 mm thickness, the proportion of reinforced volume represents already astonishingly 33 vol % of the ball volume.

| Nominal ball | | Shell thickness (mm) | | | | | |
|---|---|---|---|---|---|---|---|
| diameter (mm) | | 2 | 3 | 4 | 5 | 10 | 15 |
| 30 | Ratio | 34.9% | 48.8% | 60.6% | 70.4% | | |
| 40 | Reinforced | 27.1% | 38.6% | 48.8% | 57.8% | 87.5% | |
| 50 | volume/ | 22.1% | 31.9% | 40.7% | 48.8% | 78.4% | 93.6% |
| 60 | Ball volume | 18.7% | 27.1% | 34.9% | 42.1% | 70.4% | 87.5% |
| 70 | | 16.2% | 23.6% | 30.5% | 37.0% | 63.6% | 81.3% |
| 80 | | 14.3% | 20.9% | 27.1% | 33.0% | 57.8% | 75.6% |
| 90 | | 12.7% | 18.7% | 24.4% | 29.8% | 52.9% | 70.4% |

In the present disclosure, the expressions TIC, TiCN, TIN, WC, WB . . . etc. should not be understood in a strict stoichiometric chemical meaning but as carbides, nitrides, borides . . . in their crystallographic structure. Titanium carbide, for example possesses a wide composition range with C/Ti stoichiometry varying from 0.47 to 1, a C/Ti stoichiometry higher than 0.8 being preferred, higher than 0.9 is even better. Titanium carbonitrides for instance are sometimes expressed as TiCN or Ti₂CN or even Ti(C,N) . . . .

The volume content of ceramic metal composite granules in the ceramic structure building the outer reinforced shell of the grinding ball (hollows parts such as inflow hole or recesses, if any, excluded) is typically comprised, according to their specific use, between 35 and 70 vol %, preferably between 40 and 65 vol %, most preferably between 45 and 60 vol % leading to average ceramic particles concentrations in the reinforced volume comprised between 14 and 67 vol %, preferably between 24 and 59 vol %, more preferably between 30 and 54 vol %.

The following table represents the volume % of the ceramic particles content considering the ceramic weight and volume % in the millimetric granules and the packing density of the granules.

| Vol % ceramic | |
|---|---|
| particles in | Weight % of ceramic particles |
| reinforced area | in granules (example TiC) |

| | | | | | |
|---|---|---|---|---|---|
| ceramic metal | 29% | 48% | 59% | 85% | 92% |

| | |
|---|---|
| granules packing | Vol % ceramic particles in granules |

| vol % | 40% | 60% | 70% | 90% | 95% |
|---|---|---|---|---|---|
| 35% | 14% | 21% | 25% | 32% | 33% |
| 40% | 16% | 24% | 28% | 36% | 38% |
| 45% | 18% | 27% | 32% | 41% | 43% |
| 50% | 20% | 30% | 35% | 45% | 48% |
| 55% | 22% | 33% | 39% | 50% | 52% |
| 60% | 24% | 36% | 42% | 54% | 57% |
| 65% | 26% | 39% | 46% | 59% | 62% |
| 70% | 28% | 42% | 49% | 63% | 67% |

The reinforced outer part of the grinding ball is produced from an aggregation of irregular millimetric ceramic metal composite granules having a particle size distribution of between approximately 0.3 to 10 mm, preferably 0.5 to 6 mm, more preferably 0.8 to 4 mm. The average particle size is preferably selected between 1 and 6 mm, more preferably between 1 and 3 mm, for example 2 mm, depending on the desired shell thickness. See FIG. 4. The particle distribution is substantially free of particles smaller than 0.3 mm, with a proportion of particles smaller than 0.5 mm of less than 5% to maintain sufficient interstices able to be infiltrated and filled by the cast metal. The suitable particle size distribution can be obtained by sieving the granules and is tailormade for the desired packing density represented in the table above.

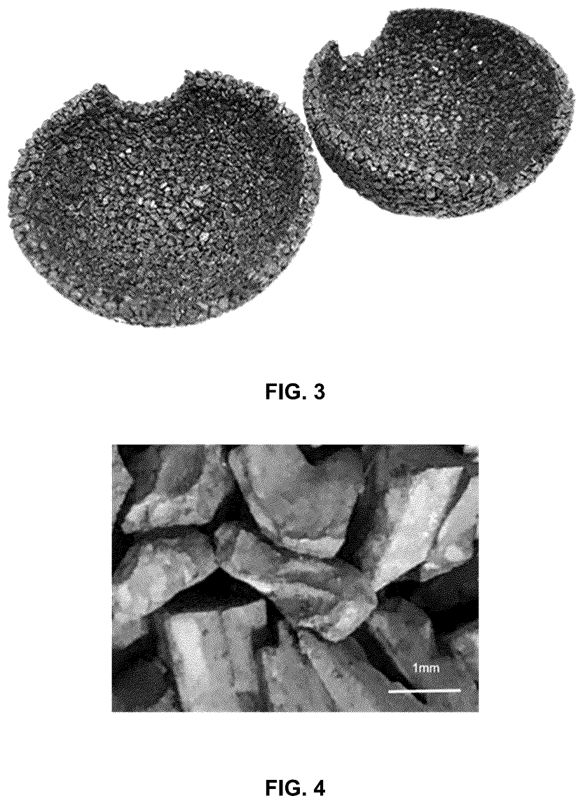

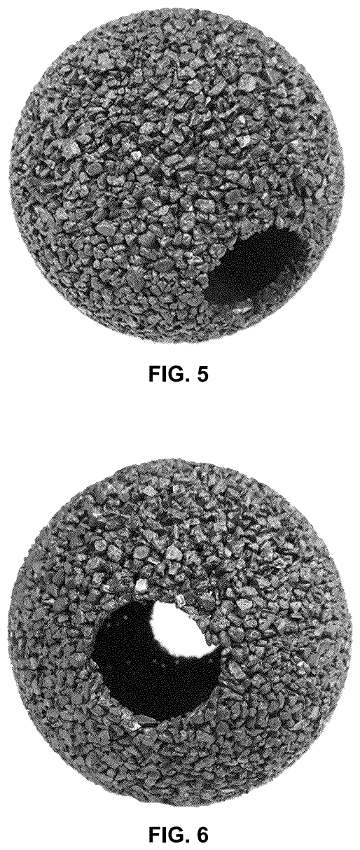

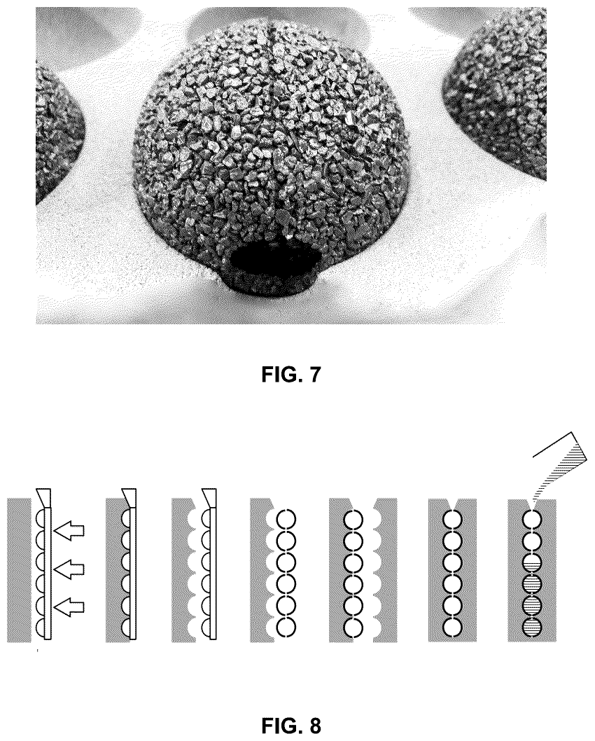

The ceramic metal composite granules are usually aggregated into two half shells (while other assembling configurations are possible) with an adhesive (inorganic like well-known sodium or potassium silicate glass glues or organic glues like two component glues leading to polyurethane or phenolic resins). These shells form an open structure of a three-dimensionally interconnected network of agglomerated/aggregated ceramic metal composite granules bound by a binding agent wherein the packing of the granules leaves open interstices between the granules, the interstices being fillable by the liquid cast metal (see FIG. 3). Two half shells are combined 2 by 2 to form a hollow sphere (see FIG. 5) and placed in the mold (see FIG. 7) prior to the pouring of the ferrous alloy to form the ceramic reinforced grinding ball. The assembling of the shells can be a mortise and tenon assembly or any other suitable assembly allowing a good behavior during the pouring of the cast metal. The connection between the shell parts being usually a weak point of the precast body, they are preferably positioned perpendicularly or at least not parallel to the parting line of the mold to avoid addition of defects (the mold parting line being already a weaker point of conventional grinding balls.)

The liquid metal is then poured into the grinding ball mold and the liquid metal fills the open interstices between the ceramic metal granules. Millimetric interstices should be understood as interstices of an average size of 0.5 to 4 mm, preferably 1 to 3 mm depending on the compaction of the ceramic reinforcement structure and the size of the granules. The size of the ceramic metal composite granules is chosen in relation to the thickness of the reinforcement shell, for reasons of mechanical resistance and infiltrability. While a thickness of the shells of 3 mm can be achieved with ceramic metal granules of an average size of about 1 to 2 mm, shells of 10 mm thickness could be achieved with ceramic metal granules of an average size of 3 to 6 mm.

The ceramic metal composite granules are usually manufactured by powder metallurgy, shaping a blend of ceramic and metallic powders of appropriate size distribution followed by a liquid-phase sintering.

Typically, the powders are 0.1-50 μm in diameter and comprise ceramic particles as the main component and 5 to 60 percent of a metallic binder which can be an individual constituent powder or already alloyed powders. The powders are first mixed and/or ground (depending on the initial powder size) in a ball mill, dry or wet grinding (for example with alcohol such as isopropyl alcohol to avoid the metallic powder oxidation). Some organic aids may be added for dispersion or shaping purposes. A drying step may be needed in case of wet grinding. This can be done by any suitable technique for example by vacuum drying or spray-drying. The shaping is usually performed by cold uniaxial, isostatic pressing roller compactor or injection molding or any other shaping methods to form a strip, a rod, a block or a sheet.

Strips or sheets, for instance, can be easily crushed to grains and possibly sifted. It can be an advantage to achieve irregular granule shapes free of easy pull-out orientation (granules very well mechanically retained in the cast metal) or rounded shape granules (granules very well metallurgically retained in the cast metal). The pressed, extruded or crushed granules are then sintered at a suitable temperature preferably under vacuum, inert gas, or combinations thereof. During liquid-phase sintering, particle rearrangement occurs, driven by capillarity forces decreasing the porosity. Crushing is also possible after the sintering step.

The cast ferrous alloy embedding the ceramic metal composite granules and filling the interstices of the outer shell of the grinding ball is preferably a ferrous alloy (chromium white iron, steel, manganese steel . . . ).

### Advantages

The present disclosure allows to obtain, by a conventional casting, a concentration of ceramic particles that can be very high in the ceramic metal composite granules (up to 95% in volume), with low risk of defects inside the cast structure (gas holes, cracks, heterogeneities . . . ).

In the present disclosure, good average concentrations of ceramics can be reached in the reinforced outer shell volume of the grinding ball, via low porosity of the ceramic metal composite granules. Values up to about 67 vol % of ceramics can be reached depending on the compaction/piling and the proportions of micrometric ceramic particles in the ceramic metal composite granules in the outer shell of the grinding ball.

The grinding ball of the present disclosure is substantially free of porosity and cracks, resulting in better mechanical and wear properties.

The size of the ceramic particles and the ceramic metal composite granules (ceramic particles+metal binder) of the present disclosure can be extensively controlled during the manufacturing process (choice of raw materials, grinding, sieving, shaping process and sintering conditions). Using sintered, millimetric ceramic metal composite granules made by powder metallurgy allows the control of grain size and porosity, use of various compositions of metallic alloys as binder metal matrix, high concentration of ceramics easy shaping of inserts without extensive need of man work, and good internal health of grains after the pouring even in high thermal shock conditions.

### Manufacturing of the Ceramic Metal Composite Granules:

The grinding and/or the mixing of the ceramic powder (40 to 95 vol %, preferably 60 to 90 vol %, more preferably 70 to 90 vol %) and metallic powders as binder metallic matrix (5 to 60 vol %, preferably 10 to 40 vol %, more preferably 10 to 30 vol %) is carried out, as mentioned above, in a ball mill with a liquid that can for example be water or alcohol, depending on metallic binder sensitivity to oxidation. Various additives (antioxidant, dispersing, binder, plasticizer, lubricant, wax for pressing,) can also be added for various purposes, before or after drying.

Once the desired average particle size D₅₀ is reached (usually below 20 μm, preferably below 10 μm, more preferably below 5 μm) the slurry is dried (for example by vacuum drying or spray drying) to achieve agglomerates of powder containing the above-mentioned organic additives.

The agglomerated powder is introduced in a roller compactor granulation apparatus through a hopper. This machine comprises two rolls under pressure, through which the powder is passed and compacted. At the outlet, a continuous strip (sheet) of compressed material is obtained which is then crushed in order to obtain the ceramic metal composite granules. These granules are then sifted to the desired size. The non-desired granule size fractions are recycled at will. The obtained granules have usually 40 to 70% relative density (depending on compaction level powder characteristics and blend composition).

It is also possible to adjust the size distribution of the granules as well as their shape to a cubic or flat shape depending on the crushing method (impact crushing will deliver more cubic granules while compression crushing will give more flat granules) or rounded shape for example by rolling the granules in a drum or belt for enough time or extending the sieving time or steps. Rounded granules are of particular interest to reduce stress concentrations inside the shell (vs angular granules). The obtained granules globally have a size that will provide, after sintering, granules between about 0.5 to 10 mm, preferably 0.8 to 6 mm, more preferably from 1 to 4 mm, even more preferably from 1 to 3 mm. Granules can also be obtained by classical, uniaxial pressing or granulating of the powder blend directly as grains or into much bigger parts that will be further crushed into granules, before or after sintering.

Finally, liquid phase sintering can be performed in a furnace at a temperature of 1200-1600° C. for several minutes or hours, under vacuum, N₂, Ar, H₂ or their mixtures, depending on the metallic phase (type and quantity of the binder) and ceramic particles type (carbide, nitride, carbonitride, boride . . . ) until the desired porosity is reached, preferably below 5 vol %, more preferably below 3 vol %, most preferably below 2 vol % and even below 1 vol %.

### Example of Realization of the Ceramic Precast Body Shell Structure

As mentioned above, the ceramic metal composite granules are agglomerated either by means of an adhesive, or by confining them in a mold or by any other means. The proportion of the adhesive does not exceed 10 wt % relative to the total weight of the granules and is preferably between 0.5 and 7 wt %. This adhesive may be inorganic or organic. An adhesive based on a sodium or potassium silicate or a bicomponent adhesive leading to a polyurethane or phenolic resin can be used.

The ceramic metal composite granules with low porosity are mixed with the adhesive and placed into the mold to form for example two half shells (see FIG. 2). After glue setting (obtained at 100° C. after water drying of the inorganic silicate glue for example, the glue setting could also be obtained by gassing with CO₂ or amine-based gas for polyurethane-based glue for example or by adding a catalyst to the glue mixture to enable hardening with time), the two half shells are hardened and can be demolded (see FIG. 3) before being assembled into a hollow ball-shape structure with at least one inflow hole (see FIG. 4). Depending on granule shape, size distribution, glue content, vibration during the positioning of the granules or tapping the granules bed while making the shells, the interconnected network structure of ceramic metal granules comprises between 35 to 70 vol %, most preferably 55 vol % of dense ceramic metal granules and 65 to 30 vol %, most preferably 45 vol % of voids (millimetric interstices) in the 3D interconnected network.

### Casting of the Grinding Balls in a Cluster Mold

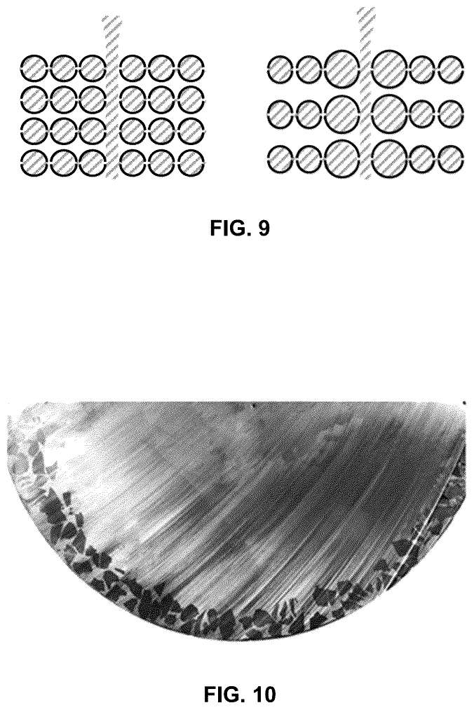

Grinding balls are usually cast in a multiple mold structure, also called “cluster mold”. In such a mold, usually up to 40 grinding balls of 40 mm and up to 16 grinding balls of 100 mm can be cast in one casting operation. See FIG. 9. Grinding balls of different sizes can also be cast together in the same cluster mold.

The assembled half shells of ceramic metal granule structure form a hollow sphere (hollow ball-shape precast structure) and comprising one or two openings (inflow holes) for the introduction of the liquid cast metal and are positioned in the cavity of a conventional sand mold or metallic shell molds. Hot liquid ferrous alloy, preferably chromium white iron or steel, is then poured into the grinding ball cluster mold.

The hot, liquid, ferrous alloy is thus infiltrating and filling the millimetric interstices between the ceramic metal granules of the reinforcing shell structure. If an organic glue is used, surface partial melting of the metallic binder matrix on the granule surface by the cast alloy or inter diffusion of elements between the 2 alloys induces a very strong bonding between the granules and the cast ferro-alloy matrix.

The sand mold is then removed, and the grinding balls are cleaned from remaining sand, and can follow the regular finishing foundry process steps known by those skilled in the art (knock-out, shot-blasting, grinding, additional heat treatments such as annealing, quenching, tempering, . . . ).

### Measurement Methods

For porosity, granule or particle size measurements, a sample is prepared for metallographic examination, which is free from grinding and polishing marks. Care must be taken to avoid tearing out of particles that can lead to a misleading evaluation of porosity. Guidelines for the specimen preparation can be found in ISO 4499-1:2020 and ISO 4499-3:2016, 8.1 and 8.2.

### Porosity Determination:

The volume fraction of porosity of the free granules can be calculated from the measured density and the theoretical density of the free granules before casting.

The measurement of the volume fraction of porosity of the granule embedded in the metal matrix is based on ISO 13383-2:2012 Annex 2. Although this standard is applied specifically to fine ceramics, the described method to measure the volume fraction of porosity can also be applied to other materials. As the samples here are not pure fine ceramics but hard metal composites, sample preparation should be done according to ISO 4499-1:2020 and ISO 4499-3:2016, 8.1 and 8.2. Etching is not necessary for porosity measurement but can be performed as it will not change the result of measurement.

### Average Ceramic Particle Size D₅₀:

The average particles size of the cemented ceramic particles is calculated by the linear-intercept method according to ISO 4499-3:2016. Five images from the microstructure of five different granules are taken with an optical or electronic microscope at a known magnification such that there are 10 to 20 ceramic particles across the field of view. Four linear-intercept lines are drawn across each calibrated image so that no individual particle is crossed more than once by a line.

Where a line intercepts a ceramic particle, the length of the line (lᵢ) is measured using a calibrated rule (where i=1, 2, 3 . . . n for the 1^{st}, 2^{nd}, 3^{rd}, . . . nth grains). Incomplete particles touching the edges of the image must be ignored. At least 200 particles must be counted.

The mean-linear-intercept particle size is defined as:

$${d}_{x} = \frac{\sum {l}_{i}}{n}$$

### Ceramic Metal Granule Average Particle Size D₅₀ Measurement

One or more photomicrographic pictures of the polished cross section of the sample are made using a computer program and optical microscope (for example a general image field obtained by an Alicona Infinite Focus). All together the pictures contain at least 250 different ceramic metal granules. An appropriate thresholding allows the segmentation of grayscale image into features of interest (the granules) and background (see FIG. 11). If the thresholding is inconsistent due to poor image quality, a manual stage involving drawing by hand the granules, the scale bar if present and the image border on a tracing paper and then scanning the tracing paper is used.

Feret diameter, which is the distance between two tangents placed perpendicular to the measuring direction, is measured in all direction for each granule by an image analysis software (ImageJ for example). An example is given in FIG. 15.

Minimum Feret diameter of each granule of the image are determined. Minimum Feret diameter is the shortest Feret diameter out of the measured set of Feret diameters. At least 250 different particles must be measured. Granules touching the edges of the image must be ignored. The value of the minimum Feret diameters of each granule is taken as the equivalent diameter x. The volume size distribution q₃(x) of the granules is then calculated based on spheres of diameter x. D₅₀ of the granules is to be understood as the volume weighted mean size x̅_̅{̅1̅,̅3̅}̅ according to ISO 9276-2:2014.

### Ceramic Metal Composite Granule Average Particle Size D₅₀ Measurement During Manufacturing of the Granules:

Granule size can be measured by dynamic image analysis according to ISO 13322-2:2006 by the mean of a Camsizer from Retsch or equivalent device. The particle diameter used for size distribution is X_{cmin} which is the shortest chord measured in the set of maximum chords of a particle projection (for a result close to screening/sieving).

Granule size D₅₀ is the volume weighted mean size of the volume distribution based on X_{c min}. Granules average particle size and distribution can also be measured by sifting according to ISO 4497:2020

### Particle Size Measurement of the Powder During the Grinding:

The particle size of the powder during the grinding is measured by laser diffraction with the MIE theory according to guidelines given in ISO 13320:2020 by the mean of a Mastersizer 2000 from Malvern. Refractive index and absorption should be set according to the measured material. For example, refractive index for TIC is set to 3 and the absorption to 1. Obscuration must be in the range 10 to 15% and the weighted residual must be less than 1%.

### Examples

Grinding balls are usually submitted to various stresses, segmented in application fields where either corrosion resistance, abrasion resistance or impact resistance is privileged. Therefore, grinding balls are supplied according to their specific use where one or more of the above-mentioned wear mechanisms are present. Grinding balls are nevertheless not only tailor made for materials to be ground but also adapted to specific grinders where diameter, liner and volumetric filling degrees play an important role. Therefore, the performance comparison of the grinding balls of the present disclosure with grinding balls of the prior art must be done in the specific context of the expected results in terms of corrosion resistance, abrasion resistance or impact resistance within a specific grinding environment.

### Examples of Grinding Balls Performed for Real Life Tests in Industrial Grinder

The present examples are illustrative for the present disclosure but are not to be considered as limitative.

### Preparation of the Ceramic Metal Composite Granules

The following raw material powders were used for 4 different types of ceramic metal composite granules 1 to 4, all powders had a particle size of less than 44 μm.

TiC, TiC_{0.5}, N_{0.5}, WC, NbC, Mo₂C, Iron, Manganese, Chromium, Nickel.

TABLE 1

| Composition | | | | |
|---|---|---|---|---|
| (wt %) | granules 1 | granules 2 | granules 3 | granules 4 |
| TiC | 45 | 85 | 85 | |
| TiC_{0.5}N_{0.5} | | | | 65 |
| WC | | | | 11 |
| NbC | | | | 5 |
| Mo₂C | | | | 4 |
| Fe | 42.6 | 11.6 | 11.6 | |
| Mn | 9.1 | | | |
| Cr | | 2.5 | 2.5 | |
| Ni | 2.2 | 0.6 | 0.6 | 15.0 |
| Mo | 1.1 | 0.3 | 0.3 | |

The composition of ceramic metal composite granules 1 is particularly suitable for impact resistance due to its lower content of ceramic particles (45 wt % TiC) cemented in a tough manganese steel binder matrix.

The composition of ceramic metal composite granules 2 and 3 are particularly suitable for abrasion resistance due to its high content of ceramic particles (85 wt % TiC) cemented in a hard high chromium white iron wear resistant binder matrix.

The composition of ceramic metal composite granules 4 is particularly suitable for corrosion resistance and wear due to its high content of a complex mix of ceramic particles (TiC_{0.5}N_{0.5}+WC+NbC+Mo₂C=85 wt % in total) fine-tuned to be cemented in a corrosion resistant nickel binder. Other ceramic particles can be added in order to create complex solid solution particles, control or fine tune grains size, morphology and/or core-rim structure of the hard ceramic particles.

Powders according to the compositions of table 1 have been mixed and ground in a ball mill with isopropyl alcohol and metallic grinding balls for 24h to reach an average particle size D₅₀ of about 3 μm.

An organic wax binder, 2 wt % in the form of powder, is added and mixed with the obtained powders. The alcohol is removed by a vacuum-dryer with rotating blades (the alcohol being condensed to be reused). The agglomerated powder obtained is then sifted through a 500 μm sieve. Strips of 60% of the theoretical density of the ceramic/metallic powder mixtures are made by compaction between the rotating rolls of a roller compactor granulator. The strips are then crushed to irregular granules by forcing them through a sieve with appropriate mesh size. After crushing, the granules are sifted to obtain the required granule size distribution. These irregular porous granules are then sintered at high temperature (a typical temperature-time couple being 1430° C. for 2 hours for example) in a high vacuum furnace with low partial pressure of argon until a minimal porosity (<5 vol %), preferably less than 3 vol % and even less than 1 vol %, if necessary, is reached.

The sintered granules with low porosity <5 vol % are then mixed with about 1 wt % of a two component polyurethane based glue (composed for example of a mix of 50 wt % of AVECURE 335 F PART 1—aromatic hydrocarbons, phenol, 2-butoxy ethyl acetate and 50 wt % of AVECURE 635 F PART 2-Diphenylmethandiisocyanate from ASK chemicals) and poured into a silicone or plastic mold (vibrations or pressure can be applied to ease the filling of the mold and packing to be sure that all the granules are correctly packed) of the desired shape (see half shell mold of FIG. 2). Ethyl-dimethylamine gas (for example AVECURE 3D from ASK Chemicals) is then used as a catalyst to harden the polyurethane, the shells, once hard enough can be demolded. Such operations can easily be automatized on core shooting machines widely used in foundry operations.

These shells, as represented in FIGS. 5 and 6, comprise about 55 vol % of dense ceramic metal composite granules (about 45 vol % of voids/millimetric interstices between the granules). Each precast hollow ball ceramic metal granule structure is positioned in the cavity of the grinding balls cluster molds (see FIG. 7). Hot liquid high-chromium white iron with appropriate composition according to the test conditions (alloy 1, alloy 2 or alloy 3) is then poured into the molds. The hot, liquid, high-chromium white iron is filling the millimetric interstices between the granules of the reinforcing shell of the grinding ball.

### Cast Alloys Used to Pour the Grinding Balls of Examples 1 to 4

| Wt % | C | Cr | Others | Fe |
|---|---|---|---|---|
| Cast Alloy 1 | 2.2 | 16.5 | <2 | Balance |
| Cast alloy 2 | 2.85 | 14.5 | <2 | Balance |
| Cast alloy 3 | 2.3 | 29 | <2 | balance |

### Example 1 (Alloy 1+Granule Composition 1)

Alloy 1 contains 2.2 wt % of C and 16.5 wt % of Cr is particularly suitable for impact conditions with an appropriate heat treatment to improve impact resistance. The granules of composition 1 are used to make the shell. Composite grinding balls and reference metallic grinding balls are compared together during a same period in a same ball mill processing the same platinum ore under significant impact conditions.

### Examples 2 and 3 (Alloy 2+Granule Composition 2 and 3)

Alloy 2 contains 2.85 wt % of C and 14.5 wt % of Cr is particularly suitable for abrasive conditions with an appropriate heat treatment to improve abrasion resistance. The granules of composition 2 and 3 are used to make the shells. Composite balls and reference metallic balls are compared in a same ball mill with copper ore under significant abrasion conditions.

### Example 4 (Alloy 3+Granule Composition 4)

Alloy 3 contains 2.3 wt % of C and 29 wt % of Cr is particularly suitable for high corrosion conditions. The granules of composition 4 are used to make the shells. Composite balls and reference metallic balls are compared in a same ball mill with magnetite iron ore under significant corrosion conditions.

By other elements it should be understood that alloy 1, 2 and 3 also contain other usual alloying elements <2 wt % (Si, Mn, Mo, Ni . . . ) known from those skilled in the art depending on specific properties and aimed heat treatment.

After pouring, 47 to 58 vol % of the shell are ceramic metal granules with a high concentration of about 57 vol % to 89 vol % of micrometric ceramic particles (such as titanium carbide, titanium carbonitride, niobium carbide, tungsten carbide . . . and/or mixtures/combinations) cemented in their binder metal matrix. The global volume content of ceramic particles in the reinforced shell after pouring of the grinding ball varies in examples 1 to 4 from about 27 to 52 vol %, but even higher values can be reached.

In the following table all variables necessary for the calculation of every relevant parameter are indicated. The word “granules” in the table stands for ceramic metal composite granules. The density and porosity of those granules are interdependent.

### Abstract of the Specificities of the Grinding Balls of Each Example on Test.

| Relevant parameters | Ex. 1 | Ex. 2 | Ex. 3 | Ex. 4 |
|---|---|---|---|---|
| Ball diameter (mm) | 80 | 90 | 90 | 70 |
| Shell thickness (mm) | 5 | 8 | 8 | 3 |
| Granules average size (mm) | 2 | 3 | 3 | 1 |
| Granule porosity (%) | 0.20% | 2.50% | 0.50% | 0.50% |
| Weight of granules in shell (g) | 251 | 489 | 499 | 126 |
| Density of the granules (g/cm³) | 6.19 | 5.07 | 5.18 | 6.12 |
| Volume of the reinforced portion (cm³) | 86.4 | 166.2 | 166.2 | 41.1 |
| reinforced volume /ball volume ratio | 32% | 44% | 44% | 23% |
| reinforced surface on ball surface ratio | 98% | 98% | 98% | 97% |
| Volume ratio of granules in the shell | 47% | 58% | 58% | 50% |
| Volume of granules in the shell (cm³) | 40.6 | 96.4 | 96.4 | 20.5 |
| Final ceramic particles content in the | 57% | 87% | 89% | 88% |
| granules (vol %) | | | | |
| Final ceramic particles content in the | 27% | 51% | 52% | 44% |
| shell (vol %) | | | | |

Performance Index Calculated in Comparison with Conventional Grinding Balls

The article “Overview of grinding media consumption in comminution” (Slabbert, Paton, Moema and Zimba) in World Gold Conference gives an overview over the testing of grinding media.

Real life tests of grinding balls on industrial grinding machines are particularly difficult to manage due to the low proportion of test grinding balls comparatively to the load of conventional grinding balls. The test samples represent generally less than 0.1% (400 balls among 400,000 to 800,000 balls) since the grinder contains grinding balls worn at various stages with a large diameter size distribution (10 to 70 mm of diameter for example). The main difficulty being here, after several days or weeks of grinding, to find at least a significant number of composite balls and reference balls among thousands of conventional grinding balls to be able to measure a representative average weight loss percentage of composite test balls to be compared to reference metallic grinding balls.

The trick to solve this problem here is to use slightly bigger grinding ball diameter (about 10 mm bigger) than those added regularly and already present in the conventional grinder. For instance, if the fresh conventional grinding balls added regularly into the industrial grinder have a diameter of 60 mm, a diameter of 70 mm for the test grinding balls (composite and reference grinding balls) is chosen to allow more easy retrieval of the marked balls. Since those balls are bigger, they are not only visually easier to find but they have a natural tendency to “float” on the surface of the conventional grinding load.

The evaluation of the wear performance of the grinding balls of the present disclosure has been performed in a real-life context of copper ore, magnetite iron ore and platinum ore grinding in 3 industrial mills A; B; C (with the following characteristics and conditions):

Grinding of Copper Ore in Presence of Grinding Balls of Example 2 Followed by a Test with Grinding Balls of Example 3 (Both 90 mm in Diameter)

### Mill a of 7.31 m Diameter and 10.97 m Length

Containing 660 Tons of conventional grinding balls (33 vol % filling).
Regular additions of several tons per day of conventional grinding balls of 76 mm diameter to compensate wear
Rotation speed of 11.9 rpm
Drawing a power of 10500 kW
Processing 950 T/h of copper ore
With abrasion conditions
Test duration: 8 days

### Grinding of Magnetite Iron Ore in Presence of Grinding Balls of Example 4 (70 mm)

### Mill B of 4.6 m of Diameter and 6.7 m of Length

Filled with 165 Tons of conventional grinding balls (35 vol % filling)·
Regular additions of several tons per day of conventional grinding balls of 60 mm diameter to compensate wear
Rotating at a speed of 15.1 rpm
Drawing a power of 2300 KW
Processing 420 T/h of magnetite iron ore
With corrosion conditions
Test duration: 20 days

### Grinding of Platinum Ore in Presence of Grinding Balls of Example 1 (80 mm)

### Mill C of 7.925 m of Diameter and 11.735 m of Length

Filled with 800 Tons of conventional grinding balls (32 vol % filling)·
Regular additions of several tons per day of conventional grinding balls of 70 mm diameter to compensate wear
Rotating at a speed between 10.5 and 11.5 rpm
Drawing a power of 15000 KW
Processing 1000 T/h of platinum ore.
With impact conditions
Test duration: 10 days

### Preparation of the Test Samples

For the performance test of the composite grinding balls of examples 1 to 4, as well as for the metallic reference ball type, 200 grinding balls of every example have been produced and each grinding ball of the same alloy and reinforcement has been marked with the same identification means (for example one or two drilled hole of defined diameter and positions in all grinding balls of example 1; 2 holes of different diameter and position in all grinding balls of example 2, etc.). All grinding balls of the same composition are further machined or ground to have the same weight (+/−2 Kg for grinding balls of 80 mm diameter) with a tolerance of +/−5 grams, preferably +/−2 grams. The composite grinding balls of the present disclosure and the reference metallic grinding balls are produced with the same ferro alloy and are submitted to the same heat treatment to be able to evaluate the influence of the reinforcement as the only variable.

In the next step, 200 composite test grinding balls and 200 reference metallic grinding balls are loaded together in the industrial mill (composite balls of Ex1 in mill C, composite balls of Ex2 and Ex3 in mill A and composite balls of Ex4 in mill B). Composite balls of Ex2 and of Ex3 are tested separately (one after the other) in mill A, each time with 200 reference metallic grinding balls.

The industrial mills described above already contain their usual load of conventional grinding balls with a filling rate of about 35 vol %. This represents 660 tons of conventional grinding balls for Mill A, 165 tons for Mill B and 800 tons for Mill C whereas the amount of composite and reference grinding balls (200 composite grinding balls and 200 reference balls in each mill) represents only between about 600 and 900 kg, thus a negligible influence of the grinding capacity. The test grinding ball addition (composite and reference grinding balls) has therefore no significative impact on the overall mill filling.

The mill needs then to run a sufficient period of time to observe enough wear to be measurable. The necessary time period is generally around a few days or weeks under 24 hour/day conditions.

Depending on the type of ore to be ground, the wear of conventional grinding balls on magnetite iron ore is known to be around 0.5 mm/100 h (about 2.4 mm after 20 days) on the diameter, whereas for copper ore it is observed to be around 1.5 mm/100 h (about 3 mm after 8 days) on the diameter. On platinum ore the wear is expected to be around 1.3 mm/100 hours (about 3 mm after 10 days). This indication related to the wear speed of conventional grinding balls was considered to choose the test duration to make sure that the wear remains into the reinforced shell thickness to have an appropriate interpretation of the effect of the reinforcement shell as such.

Finally, the mill is stopped, and the test grinding balls which were found and identified (usually less than 10% of the start quantity) were weighted to evaluate the average mass loss and compute the performance index as shown in result table below.

### Performance Index Calculation

For each example of grinding balls, the average weight loss is measured before and after the test duration and an average weight loss percentage is calculated.

weight loss percentage=(initial weight−final weight)/initial weight

A performance index is defined as below, the weight loss of reference being the average weight loss of the reference metallic grinding balls.

PI=average weight loss of reference metallic grinding balls/average weight loss of test composite grinding balls

Performance index above 1 means that the test composite grinding ball according to the present disclosure is less worn than the reference, below 1 means that the test composite grinding ball is more worn than the reference. The reference grinding ball being a conventional grinding ball made of the same cast alloy but without any ceramic reinforcement.

As represented in the table below, the grinding balls of the present disclosure show in average a better performance due to the reinforced shell.

| | Granule | Cast alloy | Performance |
|---|---|---|---|
| Example | composition | composition | index |
| 1 | 1 | 1 | 2.3 |
| 2 | 2 | 2 | 2.7 |
| 3 | 3 | 2 | 4 |
| 4 | 4 | 3 | 3.1 |

The performance of the composite grinding balls of the present disclosure is compared to conventional grinding balls as mentioned above and as long as the reinforced shell is not entirely worn and has completely disappeared, therefore the thickness of the reinforcement shell has naturally an influence on the global performance of the grinding ball. A grinding ball with a composite reinforcement shell of 10 mm thickness will have a better performance on the long term than its equivalent with a reinforcement shell of 5 mm thickness.

### Influence of the Performance Index on the Global Grinding Performance

The following table compares the wear, in average weight loss percentage, of examples 1 to 4 (composite grinding balls) to their respective reference grinding balls. The increased lifetime is calculated considering their performance index and its influence on the lifetime of the grinding ball.

The lifetime of a grinding ball is usually evaluated as the time needed to wear the ball from its initial diameter down to 20 mm. Once the grinding ball diameter has reached 20 mm, the ball is considered small enough to leave the mill with the ground material through the outlet trunnion.

The measured weight loss is transformed into a diameter reduction per unit of time allowing the calculation of the increased lifetime.

A significant gain of lifetime due to the reinforced shell structure is observed allowing the grinding ball to maintain, for a longer period of time, a diameter close to its original value.

| | | Reinforced | | Weight | |
|---|---|---|---|---|---|
| | | Shell | | Loss | Increased |
| | Diameter | thickness | Weight | Reference | lifetime |
| Examples | (mm) | (mm) | Loss (%) | (%) | (hours) |
| 1 | 80 | 5 | 5.1% | 11.8% | 1050 |
| 2 | 90 | 8 | 3.7% | 9.9% | 1800 |
| 3 | 90 | 8 | 2.5% | 9.9% | 3200 |
| 4 | 70 | 3 | 3.5% | 10.7% | 2400 |

Examples 1 to 4, shows the significantly better performance of composite core-shell grinding balls with various composition and properties of granules, cast alloys and conditions of test. Example 3 shows the best performance of the composite shell in case of granules without significant porosity. Performance index of example 2 shows the influence of higher porosity in the granules.

### Advantages of the Present Disclosure

The present disclosure has the following advantages in comparison with conventional grinding balls:
Better wear performance efficiency due to better wear performance of the shell layer representing most of the wearable volume (useless to have the reinforcement everywhere inside the ball)
Better wear performance and/or mechanical properties of the composite grinding balls by tailoring the nature, the size and volume content of ceramic particles and use of an appropriate metal binder matrix for the ceramic metal composite granules such as for example high mechanical properties manganese steel combined to the appropriate ferrous cast alloy such as for example high chromium white iron for the wear part, the binder metal matrix possibly being different and complementary to the cast ferro alloy metal matrix.
Better wear performance and/or mechanical properties of the grinding balls due to controlled porosity and/or crack defects in granules prior to pouring.
Easy/simple process

### CLAUSES

The present disclosure of metal ceramic composite grinding balls can also be described as:

A metal matrix composite grinding ball with a ceramic reinforced shell structure of millimetric ceramic metal grains of a porosity of less than 5%, preferably less than 3 vol %, most preferably less than 1 vol %. The millimetric grains comprising ceramic particles cemented in a binder metal matrix with a concentration higher than 40%, the reinforcing outer shell having a thickness of between 2 and 20 mm, preferably 3 and 15 mm more preferably 4 to 12 mm and the reinforced volume representing more than 10 vol %, preferably more that 15% of the total volume of the grinding ball.

A metal matrix composite grinding ball having a core-shell structure, the shell comprising a ceramic reinforcement, the ceramic reinforcement comprising an interconnected network of ceramic metal composite granules with interstices and one or two substantially circular surfaces free of ceramic reinforcement, said circular surfaces representing less than 10% of the total surface of the shell, the ceramic metal composite granules presenting average sizes D₅₀ of between 2 and 5 mm, preferably of between 2 and 3 mm and interstices presenting average sizes D₅₀ of between 0.5 and 3 mm;
the ceramic metal composite granules comprising at least 40 vol %, preferably at least 65 vol %, most preferably at least 85 vol % of ceramic particles cemented in a binder metal matrix, the ceramic particles having average sizes D₅₀ of between 2 and 5 μm;
the ceramic metal composite granules having a volume fraction of porosity of less than 5 vol %, preferably less than 3 vol %, most preferably less than 1 vol % measured according to ISO 13383-2:2012;
the network of composite granules with interstices being embedded in a ferrous alloy cast metal matrix, wherein the ferrous alloy cast metal matrix infiltrates into and fills the interstices between the interconnected composite granules of the three-dimensionally network;
the shell comprising the ceramic reinforcement comprising a volume content of ceramic metal composite granules of at least 40 vol %, preferably at least 45 vol %, the ceramic reinforcement of the shell covering the largest part of the outer surface of the grinding ball except for a small surface due to one or two inflow holes.

1. A composite grinding ball having a core-shell structure, the shell of the core-shell structure comprising a ceramic reinforcement, the ceramic reinforcement comprising:
a three-dimensionally interconnected network of periodically alternating ceramic metal composite granules with interstices, the ceramic metal composite granules and interstices having an average size within the millimetric range;
the ceramic metal composite granules comprising at least 40 vol % of ceramic particles cemented in a binder metal matrix, the ceramic particles having average sizes within the micrometric range;
the three-dimensionally interconnected network of ceramic metal composite granules with interstices being embedded in a ferrous alloy cast metal matrix, wherein the ferrous alloy cast metal matrix fills the interstices between the interconnected ceramic metal composite granules of the three-dimensionally interconnected network;
the ceramic metal composite granules embedded in the ferrous alloy cast metal matrix having a volume fraction of porosity of less than 5 vol %, the porosity measurement being based on ISO 13383-2:2012 Annex A;
the shell comprising a volume content of ceramic metal composite granules of at least 35 vol %;
the ceramic reinforcement of the shell covering at least 85% of a total surface of the grinding ball.

2. The composite grinding ball according to claim 1, wherein the ceramic particles include one or more materials selected from the group consisting of carbides, nitrides, carbonitrides, and borides.

3. The composite grinding ball according to claim 1, wherein the ceramic particles are selected from the group consisting of titanium carbide, titanium carbo-nitride, tungsten carbide, niobium carbide, tantalum carbide, vanadium carbide, zirconium carbide, hafnium carbide, and molybdenum carbide.

4. The composite grinding ball according to claim 1, wherein a thickness of the ceramic reinforced shell ranges between 2 and 15 mm.

5. The composite grinding ball according to claim 1, wherein the embedded ceramic metal composite granules have a particle size volume distribution between 0.3 and 10 mm and an average granule size D₅₀ between 1 and 4 mm and wherein the average particle size D₅₀ can be measured by performing a photo-micrographic view, such that there are at least 250 ceramic metal composite granules across a field of view of one or more polished cross sections of one or more samples, using a computer program and optical microscope wherein an appropriate threshold allows a segmentation of the granules in grayscale image and background.

6. The composite grinding ball according to claim 1, wherein the cemented ceramic particles in the binder metal matrix have a particle size between 0.1 and 50 μm and an average particle size D₅₀ between 0.5 and 20 μm.

7. The composite grinding ball according to claim 1, wherein the binder metal matrix is selected from the group consisting of ferromanganese-based alloy, ferrochromium-based alloy, and nickel-based alloy.

8. The composite grinding ball according to claim 1, wherein the ferro alloy cast metal matrix comprises high chromium white iron, comprising at least 11 wt % of chromium, or steel.

9. Method A method for manufacturing the composite grinding ball according to claim 1, the method comprising:
a) providing or manufacturing ceramic metal composite granules comprising at least 40 vol % of micrometric ceramic particles cemented in a binder metal matrix, the ceramic metal composite granules having a porosity of less than 5 vol %;
b) manufacturing ceramic precast body shells of a three-dimensionally interconnected network of periodically alternating millimetric ceramic metal composite granules obtained in step a) with millimetric interstices;
c) assembling the shells obtained in step b) into hollow spheres comprising one or two inflow openings and positioning the hollow spheres in cavities of a mold of the grinding balls to be cast;
d) pouring the grinding balls and simultaneously infiltrating the millimetric interstices of the three-dimensionally interconnected network of the shells, positioned according to step c), with the ferro alloy cast metal matrix; and
e) demolding the composite grinding balls.

10. The method of claim 9, further comprising manufacturing the ceramic metal composite granules of step a); by:
grinding powder compositions comprising the ceramic particles and the binder metal matrix in presence of a solvent;
mixing 1 to 10% of wax to the powder composition;
removing the solvent by drying to obtain an agglomerated powder;
compacting the agglomerated powder into strips, sheets, or rods;
crushing the strips, sheets, or rods into granules in the millimetric size range; and
sintering the ceramic metal granules at a temperature between 1200 and 1600° C. in a vacuum or inert atmosphere furnace until a porosity of less than 5 vol %.

11. The method according to claim 10, wherein grinding the powder compositions comprising the ceramic particles and the binder metal matrix in presence of the solvent is performed until an average particle size D₅₀ between 1 and 20 μm is obtained, the particle size of the powder being measured by laser diffraction with the MIE theory according to guidelines given in ISO 13320:2020 wherein the refractive index and absorption is adapted to the ceramic particles and the obscuration in the range of 10 to 15%, and a weighted residual being less than 1%.

12. The method according to claim 10, wherein the sintered granules crushed from strips, sheets, or rods have a granule size between 0.3 and 10 mm the average particle size D₅₀ being selected between 1 and 6 mm, the granule size being measured by dynamic image analysis according to ISO 13322-2:2006, or by sifting according to ISO 4497:2020.

13. The method of claim 10, wherein step b) comprises:
mixing the ceramic metal composite granules obtained in step a) with about 0.5 to 7 wt % of adhesive;
pouring and compacting the mix in a shell mold;
drying the mix at appropriate temperature and time to remove the solvent of the adhesive or enable curing by gazing or catalyst;
demolding the dried mix and obtaining shells of the three-dimensionally interconnected network of periodically alternating millimetric ceramic metal composite granules with millimetric interstices, to be assembled into a hollow precast body positioned in the composite grinding ball mold.

14. The composite grinding ball according to claim 1, wherein the ceramic metal composite granules comprise at least 60 vol % of ceramic particles cemented in the binder metal matrix.

15. The composite grinding ball according to claim 1, wherein the ceramic metal composite granules embedded in the ferrous alloy cast metal matrix have a volume fraction of porosity of less than 3 vol %.

16. The composite grinding ball according to claim 3, wherein the binder metal matrix is selected from the group consisting of ferromanganese-based alloy, ferrochromium-based alloy, and nickel-based alloy.

17. A composite grinding ball having a core-shell structure, the shell of the core-shell structure comprising a ceramic reinforcement, the ceramic reinforcement comprising:
a three-dimensionally interconnected network of ceramic metal composite granules with interstices, the ceramic metal composite granules and interstices having an average size from 0.5 to 4 mm;
the ceramic metal composite granules comprising at least 40 vol % of ceramic particles cemented in a binder metal matrix, the ceramic particles having average sizes from 0.1 to 50 μm;
the three-dimensionally interconnected network of ceramic metal composite granules with interstices being embedded in a ferrous alloy cast metal matrix that fills the interstices between the interconnected ceramic metal composite granules of the three-dimensionally interconnected network;
the ceramic metal composite granules embedded in the ferrous alloy cast metal matrix having a porosity of less than 5 vol % measured according to ISO 13383-2:2012 Annex A;
the shell comprising a volume content of ceramic metal composite granules of at least 35 vol %; and
the ceramic reinforcement of the shell covering at least 85% of a total surface of the grinding ball.

18. The composite grinding ball according to claim 17,
wherein the ceramic particles include one or more materials selected from the group consisting of carbides, nitrides, carbonitrides, and borides;
wherein a thickness of the ceramic reinforced shell is between 2 and 15 mm; and
wherein the ceramic metal composite granules comprise at least 60 vol % of ceramic particles cemented in the binder metal matrix.

19. The composite grinding ball according to claim 17, wherein the ceramic metal composite granules embedded in the ferrous alloy cast metal matrix have a volume fraction of porosity of less than 3 vol %.

20. The composite grinding ball according to claim 17, wherein the binder metal matrix is selected from the group consisting of ferromanganese-based alloy, ferrochromium-based alloy and nickel-based alloy; and
wherein the ferro alloy cast metal matrix comprises high chromium white iron, comprising at least 11 wt % of chromium, or steel.
